(19) United States
(12) Patent Application Publication
(10) Pub. No.: US 2017/0221036 A1
(43) Pub. Date: Aug. 3, 2017

(54) CHECKOUT SYSTEM AND SETTLEMENT APPARATUS

(71) Applicant: TOSHIBA TEC KABUSHIKI KAISHA, Tokyo (JP)

(72) Inventor: Daichi MIYAKAWA, Izunokuni Shizuoka (JP)

(21) Appl. No.: 15/422,574

(22) Filed: Feb. 2, 2017

(30) Foreign Application Priority Data
Feb. 3, 2016 (JP) 2016-019274

(51) Int. Cl. G06Q 20/20; G06K 7/10

(52) U.S. Cl. CPC G06Q 20/208; G06K 7/10861

(57) ABSTRACT

A checkout system includes a plurality of settlement apparatuses and a registration apparatus. The registration apparatus includes a scanner, a storage unit, a communication interface, and a processor. The processor controls the scanner, the storage unit and the communication interface to identify a commodity corresponding to a scanned code, generate the settlement information, and transmit the settlement information to a selected one of the plurality of settlement apparatuses. The selected one of the plurality of settlement apparatuses determines, with respect to itself, whether a settlement processing is currently being performed and whether an error state currently exists. Based on the determination, the selected one of the plurality of settlement apparatuses performs one of the settlement processing with respect to the received settlement information and transmission of the settlement information to another one of the plurality of settlement apparatuses.

### CROSS-REFERENCE TO RELATED APPLICATION

This application is based upon and claims the benefit of priority from Japanese Patent Application No. 2016-019274, filed Feb. 3, 2016, the entire contents of which are incorporated herein by reference.

### FIELD

Embodiments described herein relate generally to a checkout system and a settlement apparatus used in the checkout system.

### BACKGROUND

In some checkout systems for retail stores, a registration apparatus for generating settlement data required for settlement of a transaction is separate from a settlement apparatus for executing a settlement processing of the transaction on the basis of the settlement data in each transaction. The registration apparatus waits for input of data relating to a commodity. If the data relating to the commodity is input by an operator, the registration apparatus generates settlement data on the basis of the data and sends the settlement data to the settlement apparatus. The settlement apparatus waits for input of payment data for the settlement data. If the payment data is input by the operator, the settlement apparatus executes the settlement processing of the transaction on the basis of the settlement data and the payment data. Such a checkout system described above includes a two-person operation in which the registration apparatus and the settlement apparatus are respectively operated by different store clerks, and a sharing operation, a so-called semi-self-service checkout system, in which the registration apparatus is operated by a store clerk and the settlement apparatus is operated by a customer.

In the case of the semi-self-service checkout system, if a customer spends much time on the operation of the settlement apparatus, customers who wait for the settlement may be inconvenienced. In order to avoid such a situation, a plurality of settlement apparatuses may be connected with one registration apparatus. Then, the registration apparatus selects any one of the settlement apparatuses for each transaction, and sends settlement data to the selected settlement apparatus.

### DESCRIPTION OF THE DRAWINGS

FIG. 1 is a schematic diagram illustrating an example checkout system according to an embodiment;

FIG. 2 is a block diagram illustrating an example configuration of a registration apparatus and a settlement apparatus.

FIG. 3 is a flowchart illustrating an example sequence of operations of an information probes-Sang executed by the registration apparatus.

FIG. 4 is a flowchart illustrating an example sequence of operations of a reception interruption processing executed by the settlement apparatus;

FIG. 5 illustrates an example registration screen;

FIG. 6 illustrates an example settlement confirmation screen; and

FIG. 7 illustrates another Example of the settlement-confirmation screen.

### DETAILED DESCRIPTION

A checkout system includes a plurality of settlement apparatuses and a registration apparatus. The registration apparatus includes a scanner, a storage unit, a communication interface, and a processor. The processor controls the scanner, the storage unit and the communication interface to identify a commodity corresponding to a scanned code, generate the settlement information, and transmit the settlement information to a selected one of the plurality of settlement apparatuses. The selected one of the plurality of settlement apparatuses determines, with respect to itself, whether a settlement processing is currently being performed and whether an error state currently exists. Based on the determination, the selected one of the plurality of settlement apparatuses performs one of the settlement processing with respect to the received settlement information and transmission of the settlement information to another one of the plurality of settlement apparatuses.

Hereinafter, an embodiment is described with reference to the accompanying drawings.

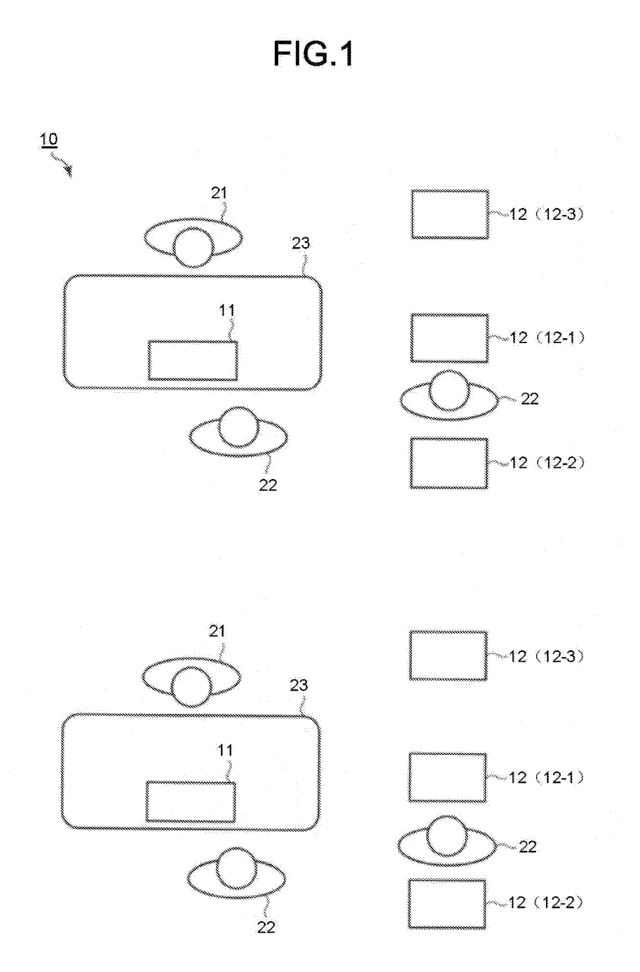

FIG. 1 is a schematic diagram illustrating a checkout system 10 according to the present embodiment. The checkout system 10 includes a plurality of registration apparatuses 11 and settlement apparatuses 12. The number of the settlement apparatuses 12 is more than that of the registration apparatuses 11.

The registration apparatus 11 and the settlement apparatus 12 are arranged at each checkout lane in a store. The number of the registration apparatuses 11 and the number of the settlement apparatuses 12 arranged in one checkout lane are not limited. In FIG. 1, a case in which one registration apparatus 11 and three settlement apparatuses 12 are arranged at each of two checkout lanes is illustrated. In detail, one registration apparatus 11 and three settlement apparatuses 12 (12-1, 12-2 and 12-3) are arranged at one checkout lane. A distance between the settlement apparatus 12-1 and the registration apparatus 11 is shortest, a distance between the settlement apparatus 12-2 and the registration apparatus 11 is second, and a distance between the settlement apparatus 12-3 and the registration apparatus 11 is farthest.

The checkout system 10 is a semi-self-service checkout system. In other words, a store clerk 21 who is generally called as a checker is an operator of the registration apparatus 11. A customer 22 whose purchased commodity is registered by the registration apparatus 11 is an operator of the settlement apparatus 12.

The registration apparatus 11 is mounted on a working table 23 in FIG. 1. The working table 23 has a rectangular top plate. Passages (checkout lanes) for customers 22 are respectively formed by arranging a plurality of the working tables 23 in such a manner that the top plates are arranged in parallel in the longitudinal directions thoseof.

The registration apparatus 11 performs functions including a sales registration processing, creation of settlement data, and transfer of the settlement data to the settlement apparatus 12. The sales registration processing includes registering data of a commodity purchased by the customer 22 in the registration apparatus 11. For example, by scanning a barcode attached to a commodity with a scanner, the data of the commodity such as a sales quantity, a sales amount and the like is registered in the registration apparatus 11. The settlement data is generated for settlement of the registered commodities as one transaction, A commodity code, a commodity name, a unit price, a sales quantity and a sales amount of each registered commodity and a total quantity and a total amount of the transaction is included in the settlement data.

The registration apparatus 11 sets one of the three settlement apparatuses 12 arranged at the same checkout lane as a sending destination for the settlement data. The settlement apparatus 12 that is set as the sending destination is optional. The registration apparatus 11 sends the settlement data to the one settlement apparatus 12 set as the sending destination.

The settlement apparatus 12 performs a function of the settlement processing. The settlement apparatus 12 processes the settlement of the transaction on the basis of the settlement data received from the registration apparatus 11. Cash, a credit card and electronic money are generally used as a payment method in the settlement.

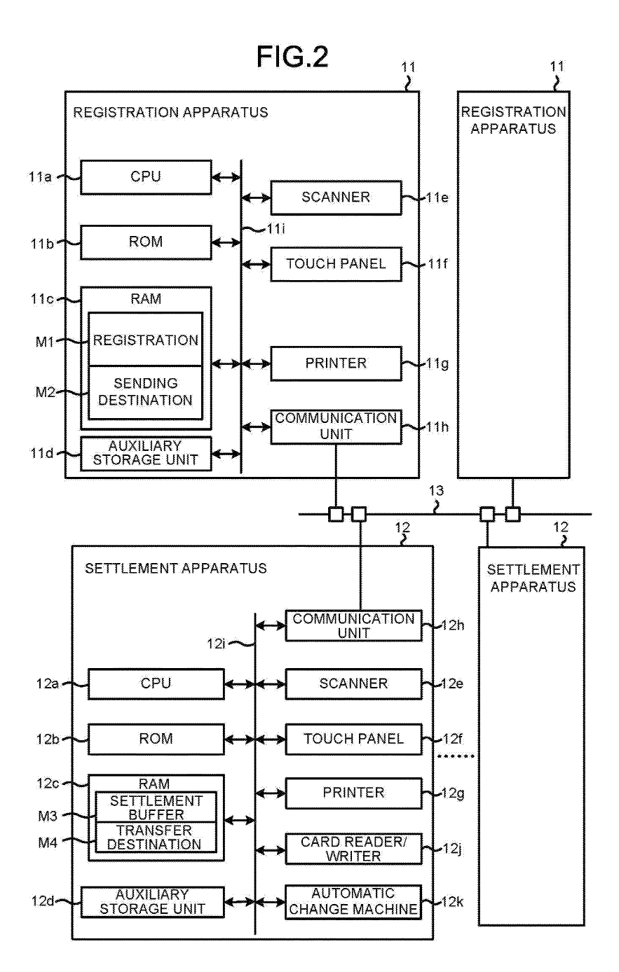

FIG. 2 is a block diagram illustrating an example configuration of the registration apparatus 11 and the settlement apparatus 12. The registration apparatus 11 and the settlement apparatus 12 at each checkout lane both are connected with a LAN (local area network) 13 serving as an in-store network. A server (not shown) is connected to the LAN 13. The server stores a commodity database in which commodity information such as a commodity name, a unit price and the like is stored in association with a commodity code of each commodity. The server may further store other databases.

The registration apparatus 11 and the settlement apparatus 12 transfer and receive information via the LAN 13. The network may be another communication network such as an Internet or a wireless LAN instead of the LAN 13. Information such as the settlement data may be transmitted and received between the registration apparatus 11 and the settlement apparatus 12 via the server.

The registration apparatus 11 includes a CPU 11a, a ROM 11b, a RAM 11c, an auxiliary storage unit 11d, a scanner 11e, a touch panel 11f, a printer 11g, a communication unit 11h and a transmission system 11i.

The CPU 11a is connected with the ROM 11b, the RAM 11c and the auxiliary storage unit 11d via the transmission system 11i and may be provided as a computer. The CPU 11a acts as a main processing unit of the computer. The CPU 11a controls each section for realizing various functions as the registration apparatus 11 according to an operating system, middleware and/or application programs stored in the ROM 11b and the RAM 11c.

The ROM 11b acts as a main storage unit of the computer. The ROM 11b stores the operating system. As occasion demands, the ROM 11b stores the middleware or application programs. Further, as occasion demands, the ROM lib also stores data required to execute various processing by the CPU 11a.

The RAM 11e acts as another main storage unit of the computer. As occasion demands, the RAM 11c stores data required to execute various processing by the CPU 11a. Furthermore, the RAM 11c is used as a so-called working area for storing data temporarily used when the CPU 11a executes various processing.

The auxiliary storage unit 11d acts as an auxiliary storage unit of the computer. The auxiliary storage unit 11d stores data used by the CPU 11a which carries out various processing, or data created in the processing by the CPU 11a. As the auxiliary storage unit 11d, for example, an EEPROM, an HDD or an SSD can be used. The application program stored in the ROM 11b or the auxiliary storage unit lid includes a control program, described below with respect to the information processing executed by the registration apparatus 11.

The scanner 11e reads a barcode attached to a commodity to acquire the commodity code of the commodity. The touch panel 11f includes a display device and a touch sensor. The touch panel 11f may include a touch panel for the store clerk and a touch panel for the customer. The touch panel 11f for the store clerk is arranged on the working table 23 in such a manner that a display screen faces the working space of the store clerk 21. The touch panel 11f for the customer is arranged on the working table 23 in such a manner that a display screen faces the passage for customer 22. The printer 11g prints various character strings or images on a receipt paper to issue a receipt. The communication unit 11h carries out data communication with the plurality of the settlement apparatuses 12 connected via the LAM 13. The communication unit 11h can also carry out the data communication with other commodity registration apparatuses 11 via the LAN 13.

The transmission system 11i transmits data to be transmitted among the CPU 11a, the ROM 11b, the RAM 11c, the auxiliary storage unit 11d, the scanner 11e, the touch panel 11f, the printer 11g and the communication unit 11h. As the transmission system 11i, a well-known, system which includes various buses such as a system bus and the like and various interface circuits for connecting these buses with each section can be used. As hardware of such a registration apparatus 11, for example, an existing POS terminal can be used.

The settlement apparatus 12 includes a CPU 12a, a ROM 12b, a RAM 12c, an auxiliary storage unit 12d, a scanner 12e, a touch panel 12f, a printer 12g, a communication unit 12h, a card reader/writer 12j, an automatic change machine 12k and a transmission system 12i.

The card reader/writer 12i performs a function of reading data recorded in a card and a function of writing data into the card. The card may be a card for settlement such as a credit card, a debit card, an electronic money card, a pre-paid card and the like. The automatic change machine 12k receives deposited coins and bills. Further, the automatic change machine 12k discharges coins and bills as change. Except for the card reader/writer 12j and the automatic change machine 12k, the CPU 12a, the ROM 12b, the RAM 12c, the auxiliary storage unit 12d, the scanner 12e, the touch panel 12f, the printer 12g, the communication unit 12h and the transmission system 12i have the same functions as the registration apparatus 11 described above. The CPU 12a is connected with the ROM 12b, the RAM 12c and the auxiliary storage unit 12d via the transmission system 12i, and may be provided as a computer. The CPU 12a controls each section for realising various functions as the settlement apparatus 12 according to an operating system, middleware and application programs stored in the ROM 12b and the RAH 12c. The application program stored in the ROM 12b or the auxiliary storage unit 12d includes a control program described below with respect to an information processing executed by the settlement apparatus 12. As hardware of such a settlement apparatus 12, a POS terminal supporting, for example, an existing self-checkout system can be used.

The checkout system 10 with such an arrangement designates data memory areas M1 and M2 in the RAM 11e of the registration apparatus 11. The data memory area M1 stores the commodity code, the commodity name, the unit price, the sales quantity and the sales amount of each commodity registered for one transaction. The commodity code is a unique code for individually identifying each commodity. The commodity code is represented by for example, the barcode assigned to each commodity, and the registration apparatus 11 can acquire the commodity code by scanning the barcode with the scanner 11e. The commodity name and the unit price are the name and the price per unit of the commodity identified by the corresponding commodity code. Hereinafter, the data memory area M1 is referred to as a registration memory M1.

The data memory area M2 stores sending destination information. The sending destination information identifies a settlement apparatus 12 as the sending destination of the settlement data. One of the plurality of the settlement apparatuses 12 is set as the sending destination of the settlement data with respect to each registration apparatus 11. For example, a default value of the sending destination information for identifying the settlement apparatus 12 set as the sending destination is stored in the auxiliary storage unit 11d, and the CPU 11a writes the default value to the data memory area M2 at the time of the startup. A unique ID is preset to each settlement apparatus 12. The ID can be used as the sending destination information. Alternatively, a number, a symbol or a code is assigned in association with the ID of each settlement apparatus 12, and may be set as the sending destination information. Hereinafter, the data memory area M2 is referred to as a sending destination memory M2.

The checkout system 10 forms data memory areas M3 and M4 in the RAM 12c of the settlement apparatus 12. The data memory area M3 stores the settlement data. Hereinafter, the data memory area M3 is referred to as a settlement buffer M3. The data memory area M4 stores transfer destination information. The transfer destination information identifies another settlement apparatus 12 serving as the transfer destination of the settlement data. One of other settlement apparatuses 12 is set as the transfer destination of the settlement data with respect to each settlement apparatus 12. For example, a default value of the transfer destination information for identifying the settlement apparatus 12 set as the transfer destination is stored in the auxiliary storage unit 12d, and the CPU 12a writes the default value into the data memory area M4 at the time of the startup. A unique ID is preset for each settlement apparatus 12. The ID can be used as the transfer destination information. Alternatively, a number, a symbol or a code is assigned in association with the ID of each settlement apparatus 12, and maybe set as the transfer destination information. Hereinafter, the data memory area M4 is referred to as a transfer destination memory M4.

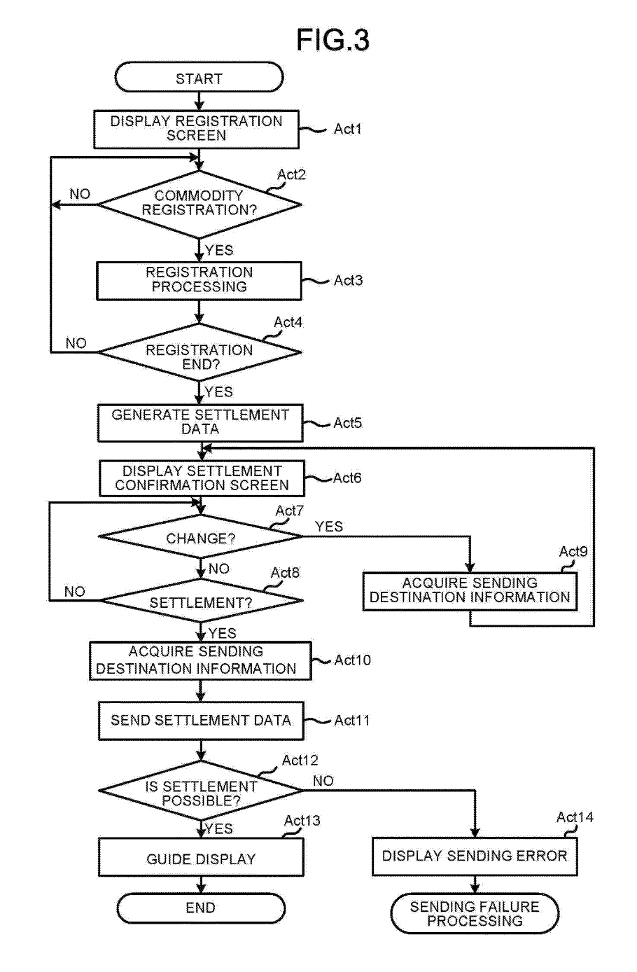

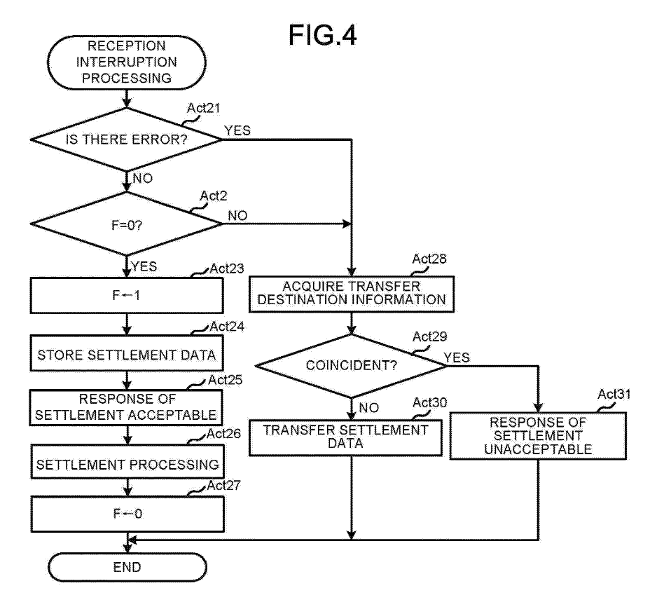

FIG. 3 is a flowchart illustrating an example sequence of operations of an information processing executed by the CPU 11a of the registration apparatus 11 according to the control program. FIG. 4 is a flowchart illustrating an example sequence of operations of an information processing executed by the CPU 12a of the settlement apparatus 12 at the time of the reception of the settlement data according to the control program. FIG. 5 to FIG. 7 illustrate examples of screens displayed on the touch panel 11f of the registration apparatus 11. Hereinafter, operations of the checkout system 10 are described with reference to FIG. 3 to FIG. 7. Furthermore, the contents of the processing described below are one example, and various processing capable of achieving the same result can be suitably utilized.

First, the operations of the registration apparatus 11 are described.

If the registration apparatus 11 is activated in a mode of carrying out the registration processing, the CPU 11a starts the information processing indicated by the procedures shown in the flowchart in FIG. 3. First, the CPU 11a displays a registration screen SC1(refer to FIG. 5) on a part of the touch panel 11f (Act 1).

The registration screen SC1 displays contents of the registration memory M1, to enable the store clerk 21 to confirm a status of the registration processing. An example of the registration screen SC1 is shown in FIG. 5. The registration screen SC1 includes display areas R1 and R2. The display area R1 displays the commodity name, the unit price, the sales quantity (number of items) and the sales amount relating to the most recently registered commodity, and the total quantity and the total amount of all registered commodities. The display area R2 displays a list of the commodity name, the unit price, the sales quantity (number of items) and the sales amount relating to commodities registered prior to the commodity shown in the display area R1.

The CPU 11a controls the touch panel 11f to display various function buttons (not shown) such as a commodity button for designating a commodity by the store clerk 21 and a subtotal button in an area outside of the registration screen SC1.

The store clerk 21 recognizes that the sales registration of the purchased commodity is possible by confirming that the registration screen SC1 is displayed on the touch panel 11f. Then, if the customer 22 with at least one commodity comes to the working table 23 , the store clerk 21 operates, for example, the scanner lie or the commodity button to sequentially input commodity codes of the commodities. If the input of all the commodity codes of the commodities of the customer is completed, the store clerk 21 touches the subtotal button. Through the foregoing operations, the sales registration of the commodities of one customer is ended.

The CPU 11a of the registration apparatus 11 executes the following information processing according to the sales registration operation described above. First, the CPU 11a waits for the commodity registration (Act 2). If the commodity code is input via the scanner 11e or the commodity button (YES in Act 2), the CPU 11a executes the registration processing of the commodity sales data (Act 3). The CPU 11a acquires the commodity information such as the commodity name, the unit price and the like set in the commodity database in association with the commodity code. Further, the CPU 11a multiplies the sales quantity by the unit price to calculate the sales amount corresponding to the sales quantity. The sales quantity is an input numerical value if it is input by a numeric keypad before the commodity code is input, and is “1” if not input through the numeric keypad. In this way, the CPU 11a creates the commodity sales data including the commodity code, the commodity name, the unit price, the sales quantity and the sales amount. Then, the CPU 11a stores the commodity sales data in the registration memory M1. At this time, the CPU 11a updates the registration screen SC1 on the basis of the data in the registration memory M1.

The CPU 11a confirms whether or not completion of the registration of the commodities is indicated (Act 4). For example, if the subtotal button is touched, the CPU 11a determines that completion of the registration is indicated. If completion of the registration is not indicated (NO in Act 4), the CPU 11a returns to the processing in Act 2 to wait for the commodity registration. If completion of the registration is indicated (YES in Act 4), the CPU 11a generates the settlement data on the basis of the data in the registration memory M1 (Act 5). The CPU 11a acts as a generation module for generating the settlement data required for the settlement of the transaction on the basis of the input data (data relating to commodity sales) through the processing in Act 2 to Act 5.

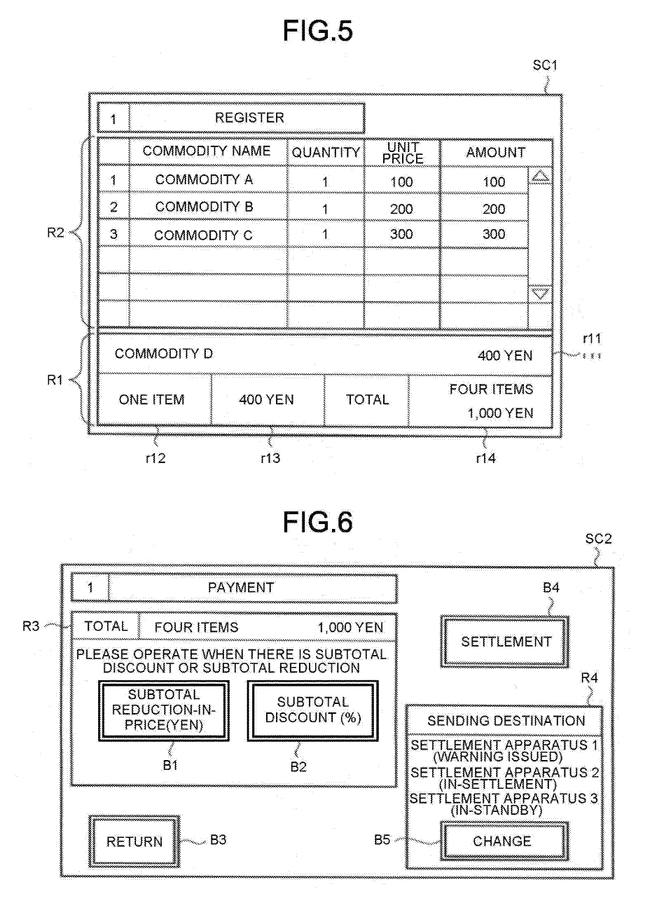

If the settlement data is generated, the CPU 11a displays a settlement confirmation screen SC2 (refer to FIG. 6) on a part of the screen of the touch panel 11f (Act 6).

An example of the settlement confirmation screen SC2 is shown in FIG. 6. The settlement confirmation screen SC2 includes display areas R3 and R4 and buttons B1, B2, B3, B4 and B5. The display area R3 displays the total quantity and the total amount of the commodities stored in the registration memory M1. A subtotal reduction-in-price button B1 and a subtotal discount button B2 are used by the store clerk 21 to designate that a discount or reduction-in-price, respectively, is applied to the total amount. The button B3 refers to a return button B3 used by the store clerk 21 to designate that a part of the area of the screen of the touch panel 11f returns to the registration screen SC1. The button B4 refers to a settlement button B4 used by the store clerk 21 to instruct the end of commodity registration relating to one transaction and the transition of the processing to the settlement.

The display area R4 displays information with which an operator, i.e., casher, is capable of specifying a settlement apparatus 12 identified with the sending destination information stored in the sending destination memory M2. Further, the display area R4 also displays a state of the settlement apparatus 12 identified with the sending destination information. The state of the settlement apparatus 12 includes “in settlement”, “warning issued” and “in-standby”. The “in-settlement” refers to a state in which the settlement processing is being executed by the settlement apparatus 12. The CPU 12a of the settlement apparatus 12 which is executing the settlement processing performs a function of generating an in-processing signal. The in-processing signal is output from the communication unit 12h to the registration apparatus 11 via the LAN 13, The “warning issued” refers to a state; in which, for example, lack of change or lack of receipt paper occurs in the settlement apparatus 12. The automatic change machine 12k performs a function of generating a warning signal of the lack of change if the residual quantity of money stored as change is less than a threshold value. The printer 12g includes a function of generating a warning signal of the lack of receipt paper if the residual quantity of receipt papers is less than a threshold value. These warning signals are output from the communication unit 12h to the registration apparatus 11 via the LAN 13. The “in-standby” refers to a state in which the settlement apparatus 12 is ready to start the settlement processing. The CPU 12a of the settlement apparatus 12 which does not execute the settlement processing and has no warning such as the lack of receipt paper or the lack of change performs a function of generating an in-standby signal. The in-standby signal is output from the communication unit 12h to the registration apparatus 11 via the LAN 13.

The CPU 11a of the registration apparatus 11 updates state information of the display area R4 upon receiving the in-processing signal, the warning signal or the in-standby signal issued from the settlement apparatus 12 identified by the sending destination information stored in the sending destination memory M2.

The button B5 refers to a change button B5 used by the store clerk 21 to instruct change of the sending destination information. For example, it is assumed that the three settlement apparatuses 12-1, 12-2 and 12-3 connected with the registration apparatus 11 are set in such a manner that the first place is the settlement apparatus 12-1, the second place is the settlement apparatus 12-2 and the third place is the settlement apparatus 12-3 as a priority of the sending destination of the settlement data. In this case, the sending destination information stored in the sending destination memory M2 is changed to information for identifying a settlement apparatus of which the priority is lower by one place each time the change button B5 is touched. If the change button B5 is touched in a state in which the information for identifying the settlement apparatus 12-3 of which the priority is lowest is stored in the sending destination memory M2, the sending destination information is changed to information for identifying the settlement apparatus 12-1 of which the priority is highest.

The store clerk 21 who confirms the settlement confirmation screen SC2 determines whether or hot it is necessary to change the sending destination of the settlement data on the basis of the information of the display area R4. For example, in a case in which the “warning issued” is displayed, it is necessary to change the sending destination of the settlement data. In this case, the store clerk 21 touches the change button B5. If it is not necessary to change the sending destination of the settlement data, the store clerk 21 touches the settlement button B4.

The CPU 11a waits for touch on the change button B5 (Act 7) or the settlement button B4 on the settlement confirmation screen SC2 (Act 8). In this state, if the change button B5 is touched (Yes in Act 7), the CPU 11a changes the sending destination information stored in the sending destination memory M2 according to the foregoing priority of the sending destination of the settlement data (Act 9). Then, the CPU 11a waits for touch on the change button B5 or the settlement button B4 again. The sending destination memory M2 acts as a storage section for storing the sending destination information in a rewritable manner. The CPU 11a acts as a change module for changing the sending destination information stored in the storage section as described above.

If the settlement button B4 is touched (Yes in Act 8), the CPU 11a acquires the sending destination information stored in the sending destination memory M2 (Act 10). Then, the CPU 11a outputs the settlement data generated in the processing in Act 5 and the sending destination information acquired in the processing in Act 10 to the communication unit 11b (Act 11). Then, the CPU 11a controls the communication unit 11h to send a data transmission message including the settlement data and the sending destination information to the address of the settlement apparatus 12 identified by the sending destination information. In response to the instruction described above, a data transmission with a sending destination address set as the communication address of the settlement apparatus 12 identified by the sending destination information and a sending source address set as the communication address of the registration apparatus is created in the communication unit 1h to send it to the LAN 13. This data transmission message is received by the settlement apparatus 12 corresponding to the communication address set as the sending destination address. The CPU 11a of the registration apparatus 11 acts as a sending module for sending the settlement data and the sending destination information for identifying the settlement apparatus 12 set as the sending destination from the plurality of the settlement apparatuses 12 in cooperation with the communication unit 1h through the processing in Act 10 and Act 11. On the other hand, the CPU 12a of the settlement apparatus 12 acts as a reception module for receiving the settlement data transferred via the network (LAN 13) in cooperation with the communication unit 12h.

The CPU 12a of the settlement apparatus 12 starts the information processing indicated by the procedures shown in the flowchart in FIG. 4 upon receiving the data transmission message via the communication unit 12h. Firstly, the CPU 12a confirms whether or not an error occurs (Act 21). The error refers to, for example, a case (no-change error) in which no money for change is stored in the automatic change machine 12k, or a case (paper-out error) in which receipt paper is out in the printer 12g. The error is not limited to the foregoing cases. For example, in a case (change-near-end) in which money for change is less than a predetermined amount or in a case (paper-near-end) in which the residual quantity of the receipt papers is less than a predetermine amount, an error may be determined to occur.

If no error occurs (NO in Act 21), the CPU 12a determines whether or not a busy flag F is reset to “0” (Act 22). The busy flag F is information of one bit which is reset to “0” while the settlement apparatus 12 does not execute settlement processing, and set to “1” while settlement processing is ongoing. The busy flag F is stored in, for example, the RAM 12c.

If the busy flag F is reset to “0” (YES in Act 22), the CPU 12a sets the busy flag F to “1” (Act 23). The CPU 12a stores the settlement data included in the data transmission message in the settlement buffer M3 (Act 24). Furthermore, the CPU 12a instructs the communication unit 12h to send a response command indicating that settlement is acceptable, to the address of the registration apparatus 11 (Act 25). The response command, with the sending destination address set as the communication address of the registration apparatus 11 and the sending source address set as the communication address of this settlement apparatus 12, is created in the communication unit 11h and sent to the LAN 13. The response command is received by the registration apparatus 11 having the communication address set as the sending destination address. The CPU 12a acts as a storage module for storing the settlement data in the storage area (settlement buffer M3) if the settlement processing of the settlement data received by the reception module is possible through the processing in Act 21 to Act 24. Further, the CPU 12a acts as an acceptance notification module for notifying the registration apparatus 11 that execution of the settlement processing is possible if the settlement processing of the settlement data received by the reception module can be executed through the processing in Act 21 to Act 25.

The CPU 12a of the settlement apparatus 12 which sends the response command indicating that the settlement is acceptable executes the settlement processing of the transaction on the basis of the settlement data stored in the settlement buffer M3 (Act 26). The settlement processing settles the transaction indicated with the settlement data in response to the operation by the customer 22. The settlement processing is the same as that carried out by an existing self-checkout POS terminal, and thus the detailed description thereof is omitted. If the settlement processing is ended, the CPU 12a resets the busy flag F to “0” (Act 27) . The CPU 12a acts as a processing module for executing the settlement processing on the basis of the settlement data stored in the storage area (settlement buffer M3) through the processing in Act 26.

On the other hand, if error occurs (YES in Act 21), or the busy flag F is set to “1” (NO in Act 22), the CPU 12a acquires the transfer destination information stored in the transfer destination memory M4 (Act 28). Then, the CPU 11a confirms whether or not the transfer destination information is the same as the sending destination information included in the data transmission message (Act 29).

If the transfer destination information is not the same as the sending destination information (NO in Act 29), the CPU 12a outputs the settlement data and the sending destination information included in the data transmission message to the communication unit 12h (Act 30). Then, the CPU 12a instructs the communication unit 12h to transfer the data transmission message including the settlement data and the sending destination information to the address of the other settlement apparatus 12 identified by the transfer destination information. In response to the instruction described above, a data transmission message, with the sending destination address set as the communication address of the settlement apparatus 12 identified by the transfer destination information, is created in the communication unit 12h, and sent to the LAN 13. The data transmission message is received by the settlement apparatus for which the communication address is set as the sending destination address among the settlement apparatuses 12 connected with the LAN 13. In other words, the communication unit 12h of the settlement apparatus 12 receives a data transmission message for which the sending destination address is the communication address of the settlement apparatus 12. The CPU 12a acts as a transfer module for confirming whether or not the settlement apparatus identified by the sending destination information received together with the settlement data is the same as another settlement apparatus set as a transfer destination for the settlement processing of the settlement data, and transferring the settlement data to another settlement apparatus set as the transfer destination via the network (LAN 13) if the identified settlement apparatus is not the same as the other settlement apparatus.

If the transfer destination information is the same as the sending destination information (YES in Act 29), the CPU 12a instructs the communication unit 12h to send a response indicating that settlement is unacceptable to the address of the registration apparatus 11 (Act 31). In response to the instruction described above, the response command, indicating that the settlement is unacceptable and for which the sending destination address is set as the communication address of the registration apparatus 11 and the sending source address is set as the communication address of the settlement apparatus 12, is created in the communication unit 12h and sent to the LAN 13. The response command is received by the registration apparatus 11 connected with the LAN 13. The CPU 12a acts as a non-acceptance notification module for notifying the registration apparatus 11 that the settlement is unacceptable via the network (LAN 13) if the settlement apparatus identified by the sending destination information received together with the settlement data is the same as the other settlement apparatus set as a transfer destination.

The CPU 11a of the registration apparatus 11 which sends the settlement data to one of the settlement apparatuses 12 set as the sending destination in the processing in Act 11 of FIG. 3 waits for the response command (Act 12). If the response command indicating that the settlement is acceptable is received via the communication unit 11h (YES in Act 12), the CPU 11a carries out guide display on the settlement confirmation screen SC2 (Act 13).

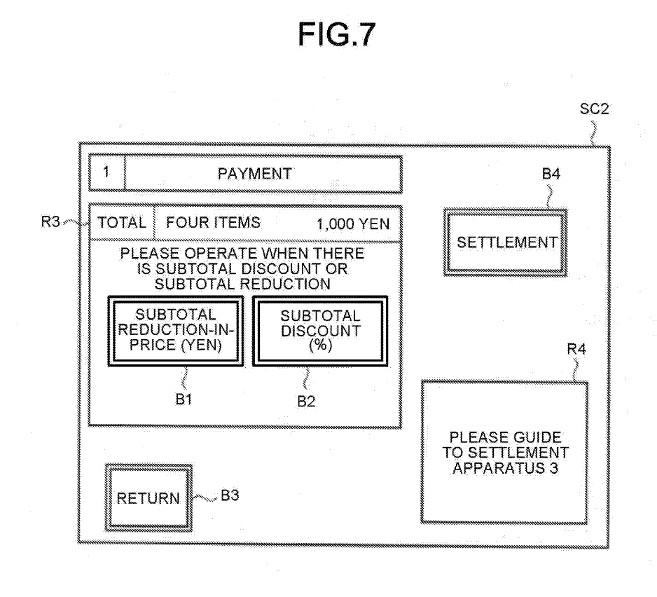

FIG. 7 illustrates an example of the settlement confirmation screen SC2 with the guide display. This example is a case in which the response command indicating that the settlement is acceptable is sent from the settlement apparatus 12-3. The guide display guides a customer to the settlement apparatus 12-3 which sent the notification that execution of the settlement processing is possible. The guide display is displayed in the display area R4. The store clerk 21 who confirms this guide display guides the customer 22 to carry out the settlement with the settlement, apparatus 12-3 indicated on the guide display. For example, the customer 22 who receives the instruction to the settlement apparatus 12-3 moves to the location at which the settlement apparatus 12-3 is installed. The CPU 11a acts as an informing module for carrying out an informing operation by which the customer is guided to the settlement apparatus in which execution of the settlement processing is possible in cooperation with the touch panel 11f through the processing in Act 12 and Act 13.

On the other hand, if receiving the response command indicating that the settlement is unacceptable from the settlement apparatus 12 (NO in Act 12), the CPU 11a displays a message indicating that the settlement data cannot be sent in an area of the settlement confirmation screen SC2, for example, the display area R4 (Act 14). After that, the CPU 11a executes a sending failure processing. In the sending failure processing, for example, a unique identification code is attached to the settlement data to send the settlement data to the server, and the printer 11g is driven to issue a settlement ticket on which a barcode indicating the identification code is printed. The settlement ticket is handed over to the customer. The customer reads the barcode of the settlement ticket with the scanner 12e of the settlement apparatus 12 installed at, for example, another checkout lane. Thus, the CPU 12a of the settlement apparatus 12 acquires the settlement data from the server, based on the identification code obtained from the barcode. Then, the CPU 12a executes the settlement processing on the basis of the settlement data.

In the checkout system 10 shown in FIG. 1, it is assumed that the settlement apparatus 12-1 is set as the sending destination with respect to the registration apparatus 11. It is also assumed that the settlement apparatus 12-2 is set as the transfer destination with respect to the settlement apparatus 12-1, the settlement apparatus 12-3 is set as the transfer destination with respect to the settlement apparatus 12-2, and the settlement apparatus 12-1 is set as the transfer destination with respect to the settlement apparatus 12-3.

In the case described above, the registration apparatus 11 sends the settlement data to the settlement apparatus 12-1 specified by the sending destination information. The settlement data includes the sending destination, information for identifying the settlement apparatus 12-1. In a case in which the settlement apparatus 12-1 can execute the settlement of the transaction, the response command indicating that the settlement is acceptable is sent from the settlement apparatus 12-1 to the registration apparatus 11. Upon receiving the response command, the guide display on which the settlement apparatus 12-1 is indicated is performed in the registration apparatus 11.

On the contrary, if the settlement apparatus 12-1 cannot execute the settlement of the transaction, the transfer destination information stored in the transfer destination memory M4 of the settlement apparatus 12-1 is not, the same as the sending destination information received together with the settlement data. Therefore, the settlement data is transferred from the settlement apparatus 12-1 to the settlement apparatus 12-2. The settlement data includes also the sending destination information for identifying the settlement apparatus 12-1. If the settlement apparatus 12-2 can execute the settlement of the transaction, the response command indicating that the settlement is acceptable is sent from the settlement apparatus 12-2 to the registration apparatus 11. The guide display on which the settlement apparatus 12-2 is indicated is performed in the registration apparatus 11 if the command is received.

However, if the settlement apparatus 12-2 cannot execute the settlement of the transaction, the transfer destination information stored in the transfer destination memory M4 of the settlement apparatus 12-2 is not coincident with the sending destination information received together with the settlement data. Therefore, the settlement data is transferred from the settlement apparatus 12-2 to the settlement apparatus 12-3. The settlement data includes also the sending destination information for identifying the settlement apparatus 12-1. If the settlement apparatus 12-3 can execute the settlement of the transaction, the response command indicating that the settlement is acceptable is sent from the settlement apparatus 12-3 to the registration apparatus 11. The guide display on which the settlement apparatus 12-3 is indicated is performed in the registration apparatus 11 if the command is received.

On the contrary, if the settlement apparatus 12-3 cannot execute the settlement of the transaction, the transfer destination information stored in the transfer destination, memory M4 of the settlement apparatus 12-3 is the same as the sending destination information received together with the settlement data. Therefore, the response command indicating that the settlement is unacceptable is sent from the settlement apparatus 12-3 to the registration apparatus 11, The sending error is displayed and the sending failure processing is executed in the registration apparatus 11 if receiving the command.

In this manner, according to the checkout system 10 described above, it is not necessary to select a settlement apparatus serving as the sending destination of the settlement data for each transaction through the registration apparatus 11 because the registration apparatus 11 simply sends the settlement data to the settlement apparatus 12 identified by the sending destination information stored in the sending destination memory M2. Thus, for example, compared with a case in which, the store clerk 21 who operates the registration apparatus 11 is required to select the settlement apparatus 12 serving as the sending destination of the settlement data for each transaction, a workload of the store clerk 21 can be reduced. Likewise, compared with a system in which the registration apparatus 11 selects the sending destination of the settlement data for each transaction on the basis of the state of each settlement apparatus 12, a processing load of the registration apparatus 11 can be reduced. Furthermore, the store clerk only has to guide the customer 22 according to the guide display, and thus a troublesome operation in which the store clerk must visually confirm which one of the settlement apparatuses 12 can carry out the settlement, processing is also eliminated.

Incidentally, in the settlement apparatus 12, there is a case in which lack of the change amount or lack of the receipt paper occurs as the settlement processing is repeated. In such a case, a warning signal is issued from the settlement apparatus 12 to the registration apparatus 11. If the warning signal is issued from the settlement apparatus 12-1 set as the sending destination to the registration apparatus 11, the state of the settlement apparatus 12-1, i.e., “warning issued” , is displayed on the settlement confirmation screen SC2 as shown in FIG. 6. Thus, the store clerk touches the change button B5. Then, the sending destination information stored in the sending destination memory M2 is changed from the information for identifying the settlement apparatus 12-1 to the information for identifying the settlement apparatus 12-2. Accordingly, the registration apparatus 11 sends the sending destination information for identifying the settlement apparatus 12-2 and the settlement data to the settlement apparatus 12-2. If the settlement apparatus 12-2 cannot execute the settlement of the transaction, the settlement data is transferred from the settlement apparatus 12-2 to the settlement apparatus 12-3. If the settlement apparatus 12-3 cannot also execute the settlement of the transaction, the settlement data is transferred from the settlement apparatus 12-3 to the settlement apparatus 12-1. Then, if the settlement apparatus 12-1 cannot still also execute the settlement of the transaction, the transfer destination information stored in the transfer destination memory M4 of the settlement apparatus 12-1 is the same as the sending destination information received together with the settlement data. Thus, the response command indicating that the settlement is unacceptable is sent from the settlement apparatus 12-1 to the registration apparatus 11. In this way, the settlement apparatus 12 which initially receives the settlement data can be changed through the touch operation by the store clerk to the change button B5, and thus frequency of the settlement processing executed by the settlement apparatus 12 in the warning issued state can be reduced easily.

The present invention is not limited to the embodiment described above.

For example, in the embodiment, a case is exemplified in which the settlement apparatus 12 includes the transfer destination memory M4, and the identification information of another settlement apparatus set as the transfer destination is stored therein. As another embodiment, the transfer destination memory M4 may store information for identifying the settlement apparatus 12 set in association with the priority set for the plurality of the settlement apparatuses 12. In this case, the CPU 12a of the settlement apparatus 12 confirms whether or not the settlement apparatus identified by the sending destination information received together with the settlement data is the same as another settlement apparatus lower in priority than the identified settlement apparatus if the settlement processing of the settlement data cannot be executed, and transfers the settlement data to the other settlement apparatus lower in priority than the identified settlement apparatus if the identified settlement apparatus is not the same as another settlement apparatus. In this way, the same effect as the present embodiment can be achieved.

Further, in the embodiment described above, the informing module is realised by carrying out the guide display on the touch panel 1f of the registration apparatus 11. The informing module is not limited to the guide display on the touch panel 11f. The customer may foe guided to the settlement apparatus 12 which can execute the settlement processing by a display output to another display medium or a voice output.

The transfer of the registration apparatus 11 and the settlement apparatus 12 is carried out in general in a state in which a program such as the control program is stored in a ROM. However, the present invention is not limited to this. The control program transferred separately from a computer apparatus may foe written into a writable storage device included in the computer apparatus in response to an operation of a user. The transfer of the control program may be recorded in a removable recording medium or can foe carried out by communication via a network. The recording medium can store the program like a CD-ROM and a memory card, and its form is not limited as long as the program can be read by the apparatus. Further, functions obtained by installation or download of the program may foe realized in cooperation with an OS (Operating System) inside the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A checkout system comprising:
a plurality of settlement apparatuses, configured to transmit and receive settlement information, and to perform settlement processing with respect to the received settlement information; and
a registration apparatus including a scanner, a storage unit, a communication, and a processor configured to control the scanner, the storage unit and the communication interface to:
identify a commodity corresponding to a code scanned by the scanner,
generate the settlement information for settling a transaction for one or more identified commodities, and
transmit the settlement information to a selected one of the plurality of settlement apparatuses, wherein
when the selected one of the plurality of settlement apparatuses receives the settlement information, the selected one of the plurality of settlement apparatuses determines, with respect to itself, whether a settlement processing is currently being performed and whether an error state currently exists,
based on the determination, the selected one of the plurality of settlement apparatuses performs one of: the settlement processing with respect to the received settlement information, transmission of the settlement information to another one of the plurality of settlement apparatuses, and transmission of the settlement information back to the registration apparatus.

2. The system according to claim 1, wherein
when the selected one of the plurality of settlement apparatuses determines, with respect to itself, that a settlement processing is not currently being performed and that an error state does not currently exist, the selected one of the plurality of settlement apparatuses performs the settlement processing with respect to the received settlement information.

3. The system according to claim 2, wherein
each of the plurality of settlement apparatuses stores an ID of another one of the plurality of settlement apparatuses assigned to the same lane,
when the selected one of the plurality of settlement apparatuses determines, with respect to itself, that a settlement processing is currently being performed or that an error state currently exists, the selected one of the plurality of settlement apparatuses determines whether the stored ID corresponds to the settlement apparatus that received the settlement information from the registration apparatus, and
when the selected one of the plurality of settlement apparatuses determines that the stored ID corresponds to the settlement apparatus that received the settlement information from the registration apparatus, the selected one of the plurality of settlement apparatuses transmits the settlement information to the registration apparatus.

4. The system according to claim 3, wherein
when the selected one of the plurality of settlement apparatuses determines that the stored ID does not correspond to the settlement apparatus that received the settlement information from the registration apparatus, the selected one of the plurality of settlement apparatuses transmits the settlement information to the settlement apparatus corresponding to the stored ID.

5. The system according to claim 3, wherein
when the selected one of the plurality of settlement apparatuses transmits the settlement information to the registration apparatus, the registration apparatus prints a paper receipt having a code printed thereon such that the settlement information can foe retrieved by scanning the code.

6. The system according to claim 2, wherein
when the selected one of the plurality of settlement apparatuses determines, with respect to itself, that a settlement processing is not currently being performed and that an error state does not currently exist, the selected one of the plurality of settlement apparatuses transmits a settlement processing confirmation to the registration apparatus.

7. The system according to claim 6, wherein
the registration unit further includes a display, and
when the registration apparatus receives the settlement processing confirmation, the processor controls the display to display a guidance screen indicating the selected one of the plurality of settlement apparatuses as a destination for a customer to complete the settlement processing.

8. A settlement apparatus for use in a checkout system comprising a plurality of the settlement apparatuses and a registration apparatus, the settlement apparatus comprising:
a communication interface,
a storage unit, and
a processor configured to control the communication interface and the storage unit to
in response to settlement information received from the registration apparatus, determine, with respect to itself, whether a settlement processing is currently being performed and whether an error state currently exists, and
based on the determination, perform, one of: the settlement processing with respect to the received settlement information, transmission of the settlement information to another one of the plurality of settlement apparatuses, and transmission of the settlement information back to the registration apparatus.

9. The apparatus according to claim 8, wherein
when the settlement apparatus determines, with respect to itself, that a settlement processing is not currently being performed and that an error state does not currently exist, the settlement apparatus performs the settlement processing with respect to the received settlement information.

10. The apparatus according to claim 9, wherein
the settlement apparatus stores an ID of another one of the plurality of settlement apparatuses,
when the settlement apparatus determines, with respect to itself, that a settlement processing is currently being performed or that an error state currently exists, the settlement apparatus determines whether the stored ID corresponds to one of the plurality of settlement apparatus that received the settlement information from the registration apparatus, and
when the settlement apparatus determines that the stored ID corresponds to one of the plurality of settlement apparatus that received the settlement information from the registration apparatus, the settlement apparatus transmits the settlement information to the registration apparatus.

11. The apparatus according to claim 9, wherein
when the settlement apparatus determines that the stored ID does not correspond to one of the plurality of settlement apparatus that received the settlement information from the registration apparatus, the settlement apparatus transmits the settlement information to the one of the plurality of settlement apparatus corresponding to the stored ID.

12. The apparatus according to claim 9, wherein
when the settlement apparatus determines, with respect to itself, that a settlement processing is not currently being performed and that an error state does not currently exist, the settlement apparatus transmits a settlement processing confirmation to the registration apparatus.

13. The apparatus according to claim 8, wherein
the settlement apparatus is further configured to:
scan a code printed on a paper receipt, and
retrieve the settlement information based on the scanned code.

14. A method for executing settlement processing in a in a system comprising a plurality of settlement apparatuses and a registration apparatus, the method comprising the steps of:
with the registration apparatus, generating settlement information for settling a transaction for one or more identified commodities;
transmitting the settlement information from the registration apparatus to a selected one of the plurality of settlement apparatuses assigned to the same lane as the registration apparatus;
determining, with respect to the selected one of the plurality of settlement apparatuses, whether a settlement processing is currently being performed and whether an error state currently exists and
based on the determination, performing one of: the settlement processing in the selected one of the plurality of settlement apparatuses with respect to the received settlement information, transmission of the settlement information to another one of the plurality of settlement apparatuses, and transmission of the settlement information back to the registration apparatus.

15. The method according to claim 14, wherein
when the selected one of the plurality of settlement apparatuses determines, with respect to itself, that a settlement processing is not currently being performed and that an error state does not currently exist, the selected one of the plurality of settlement apparatuses performs the settlement processing with respect to the received settlement information,

16. The method according to claim 15, wherein each of the plurality of settlement apparatuses stores an ID of another one of the plurality of settlement apparatuses, the method further comprising
when the selected one of the plurality of settlement apparatuses determines, with respect to itself, that a settlement processing is currently being performed or that an error state currently exists, determining whether the ID stored in the selected one of the plurality of settlement apparatuses corresponds to the settlement apparatus that received the settlement information from the registration apparatus, and
when the selected one of the plurality of settlement apparatuses determines that the stored ID corresponds to to the settlement apparatus that received the settlement information from the registration apparatus, transmitting the settlement information from the selected one of the plurality of settlement apparatuses to the registration apparatus that generated the settlement information.

17. The method according to claim 15, wherein each of the plurality of settlement apparatuses stores an ID of another one of the plurality of settlement apparatuses; the method further comprising:
when the selected one of the plurality of settlement apparatuses determines that the stored ID does not correspond to the settlement apparatus that received the settlement information from the registration apparatus, transmitting the settlement information from the selected one of the plurality of settlement apparatuses to the settlement apparatus corresponding to the stored ID.

18. The method according to claim 16, wherein
each registration apparatus further includes a display, the method further comprising:
when the selected one of the plurality of settlement apparatuses transmits the settlement information to the registration apparatus, printing, with the registration apparatus, a paper receipt having a code printed thereon such that the settlement information can be retrieved by scanning the code.

19. The method according to claim 18, further comprising:
scanning the code with a scanner;
retrieving the settlement information based on the scanned code;
performing the settlement processing with respect to the settlement information; and
transmitting a settlement processing confirmation to the registration apparatus.

20. The method according to claim 15, further comprising:
when the selected one of the plurality of settlement apparatuses determines, with respect to itself, that a settlement processing is not currently being performed and that an error state does not currently exist, transmitting a settlement processing confirmation from the selected one of the plurality of settlement apparatuses to the registration apparatus; and
displaying, with the registration apparatus, a guidance screen indicating the selected one of the plurality of settlement apparatuses as a destination for a customer to complete the settlement processing.
